(19) United States
(12) Patent Application Publication
(10) Pub. No.: US 2025/0121319 A1
(43) Pub. Date: Apr. 17, 2025

(54) MOISTURE ABSORBING DEVICE FOR DEHUMIDIFIER AND DEHUMIDIFIER

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 18/770,840

(22) Filed: Jul. 12, 2024

(30) Foreign Application Priority Data
Oct. 16, 2023 (JP) 2023-178479

(51) Int. Cl. B01D 53/26; B01D 53/06; B01J 20/28; B01J 20/34; F24F 3/14

(52) U.S. Cl. CPC B01D 53/261; B01D 53/06; B01J 20/28045; B01J 20/3441; F24F 3/1423; B01D 2253/3425; B01D 2257/80; B01D 2257/90; B01D 2258/06; F24F 2003/144; F24F 2003/1464; F24F 2203/1032

(57) ABSTRACT

A moisture absorbing device for humidifiers includes: a honeycomb structure having an outer peripheral wall and partition walls disposed on an inner side of the outer peripheral wall, the partition walls defining a plurality of cells, each of the cells extending from a first end face to a second end face to form a flow path; and a moisture absorbing material-containing layer provided on a surface of each of the partition walls. The honeycomb structure has a thickness of each of the partition walls of 0.089 to 0.140 mm and a cell density of 62.0 to 93.0 cells/cm².

### CROSS REFERENCE TO RELATED APPLICATIONS

The present invention claims the benefit of priority to Japanese Patent Application No 2023-178479 filed on Oct. 16, 2023 with the Japanese Patent Office, the entire contents of which are incorporated herein by reference in its entirety.

### FIELD OF THE INVENTION

The present invention relates to a moisture absorbing device for dehumidifiers and a dehumidifier.

### BACKGROUND OF THE INVENTION

During the rainy season and winter, it is difficult to dry laundry outdoors due to high humidity. In recent years, as lifestyles change, there is a growing demand for drying laundry indoors at any time. Therefore, dehumidifiers have become popular for using indoor residential or non-residential areas as drying places for laundry. The dehumidifiers are also used for air conditioning to improve the indoor environment.

Conventional dehumidifiers are known to have a dehumidifying rotor rotatably supported, a heater for heating the dehumidifying rotor, a cooler for cooling air heated by the heater and passing through the dehumidifying rotor, and a blower for feeding the air into the heater. The conventional dehumidifiers having such a structure can regenerate the dehumidifying rotor (remove moisture adsorbed on the dehumidifying rotor) by feeding the air heated by the heater to the dehumidifying rotor. However, since the heater is difficult to heat the air evenly, the temperature of the air fed to the dehumidifying rotor becomes uneven, and the regeneration of the dehumidifying rotor may not proceed efficiently.

Therefore, Patent Literature 1 proposes a technique for equalizing the temperature of the air fed to the dehumidifying rotor by providing a rectifying member for rectifying the air fed by the blower and feeding it to the heater.

However, the dehumidifier of Patent Literature 1 is based on the premise that the heater is used to regenerate the dehumidifying rotor, which increases the number of heater-related parts forming the dehumidifier and is also disadvantageous in terms of downsizing the dehumidifier. Also, the dehumidifier indirectly heats the dehumidifying rotor via the air heated by the heater, and does not directly heat the dehumidifying rotor, resulting in a large heating loss of the dehumidifying rotor. For these reasons, it is desirable to develop a dehumidifier that does not use a heater.

On the other hand, as an air conditioning device that does not require the use of the heater, Patent Document 2 proposes a heater element with a functional material-containing layer (e.g., an adsorbent material) provided with a honeycomb structure and a functional material-containing layer on a surface of each of the partition walls making up the honeycomb structure. In the air conditioning device, the honeycomb structure generates heat by applying a voltage to the honeycomb structure, and thus the functional material-containing layer can be regenerated without using any heater.

However, since the air conditioning device is used in a vehicle interior of an automobile or the like where a space is relatively limited, the desired effect cannot be obtained when it is used in a room interior of a house where a space is larger. For example, when the air conditioning device of Patent Literature 2, which uses a moisture absorbing material as a functional material, is used in the room interior of the house, an amount of dehumidification will be insufficient.

It is considered that the amount of dehumidification can be improved by increasing an amount of the moisture absorbing material in the layer containing the moisture absorbing material (functional material), but it results in only an increase in a thickness of the moisture absorbing material-containing layer, and the moisture absorbing material cannot be effectively used, so that only a slight effect of improving the amount of dehumidification will be achieved. It is also considered that the surface area of the moisture absorbing material-containing layer is increased by increasing the cell density of the honeycomb structure, but this will increase the pressure loss. Also, it will result in difficulty for use in a dehumidifier used in the room interior of the house because the electric current flows more easily when the voltage is applied. Conversely, if the cell density is lower, it will be difficult to heat the honeycomb structure uniformly because of the difficulty of current flow. Thus, there have been circumstances where the air conditioning device used in the vehicle interior cannot be simply applied to the dehumidifier.

The present invention was made to solve the problems as described above. An object of the present invention is to provide a dehumidifying device for dehumidifiers that can efficiently regenerate a moisture absorbing material-containing layer without using any heater and that can reduce the number of parts making up the dehumidifier to reduce the size of the dehumidifier, as well as a dehumidifier that uses the dehumidifying device for dehumidifiers.

### PRIOR ART

### Patent Literatures

[Patent Literature 1] Japanese Patent Application Publication No. 2021-151648 A

[Patent Literature 2] WO 2022/264886 A1

### SUMMARY OF THE INVENTION

As a result of intensive studies to solve the above problems, the present inventors have found that provision of a moisture absorbing material-containing layer on a surface of each of partition walls of a honeycomb structure with a controlled thickness of the partition walls and a controlled cell density in predetermined ranges can result in a moisture absorbing device suitable for dehumidifiers. Thus, the present invention is illustrated follows:

A moisture absorbing device for humidifiers, the device comprising: a honeycomb structure having an outer peripheral wall and partition walls disposed on an inner side of the outer peripheral wall, the partition walls defining a plurality of cells, each of the cells extending from a first end face to a second end face to form a flow path; and a moisture absorbing material-containing layer provided on a surface of each of the partition walls, wherein the honeycomb structure has a thickness of each of the partition walls of 0.089 to 0.140 mm and a cell density of 62.0 to 93.0 cells/cm².

The moisture absorbing device for dehumidifiers according to [1], wherein at least the partition walls are made of a material having a PTC property.

The moisture absorbing device for dehumidifiers according to [1] or [2], wherein the thickness of each of the partition walls is 0.101 to 0.138 mm.

The moisture absorption device for dehumidifiers according to any one of [1] to [3], further comprising: a pair of electrodes provided on the first end face and the second end face of the honeycomb structure, or on opposing surfaces of the outer peripheral wall parallel to an extension direction of the cells; and terminals connected to the electrodes.

The moisture absorbing device for dehumidifiers according to any one of [1] to [4], wherein the moisture absorbing material-containing layer is capable of absorbing moisture and odorous components.

A dehumidifier comprising the moisture absorbing device for dehumidifiers according to any one of [1] to [5].

A dehumidifier comprising:

a casing having a dehumidification flow path and a regeneration flow path;

the moisture absorbing device for dehumidifiers according to any one of [1] to [5], the moisture absorbing device being rotatably disposed across the dehumidification flow path and the regeneration flow path;

a first fan disposed in the dehumidification flow path, the first fan sucking ambient air to discharge the air dehumidified by the moisture absorbing device for dehumidifiers to the surroundings;

a second fan disposed in the regeneration flow path, the second fan circulating the air dehumidified by the moisture absorbing device for dehumidifiers;

a heat exchanger disposed in the regeneration flow path, the heat exchanger cooling and condensing the air dehumidified by the moisture absorbing device for dehumidifiers; and

a tank for storing condensed water generated by the heat exchanger, wherein the moisture absorbing device for dehumidifiers can be heated by applying a voltage to release the moisture.

The dehumidifier according to [7], wherein the voltage applied to the moisture absorbing device for dehumidifiers is 12 V or more and less than 200 V.

### BRIEF DESCRIPTION OF THE DRAWINGS

FIG. 1A is a cross-sectional view of a moisture absorbing device for dehumidifiers according to an embodiment of the present invention, which is parallel to a flow path direction;

FIG. 1B is a cross-sectional view taken along the line a-a′ in FIG. 1A; and

FIG. 2 is a schematic view of a dehumidifier according to an embodiment of the present invention.

### DETAILED DESCRIPTION OF THE INVENTION

The moisture absorbing device for humidifiers according to an embodiment of the present invention includes: a honeycomb structure having an outer peripheral wall and partition walls disposed on an inner side of the outer peripheral wall, the partition walls defining a plurality of cells, each of the cells extending from a first end face to a second end face to form a flow path; and a moisture absorbing material-containing layer provided on a surface of each of the partition walls. The honeycomb structure has a thickness of each of the partition walls of 0.089 to 0.140 mm and a cell density of 62.0 to 93.0 cells/cm². With such a configuration, the honeycomb structure can be heated by applying the voltage to the honeycomb structure without using any heater, so that the moisture absorbing material-containing layer can be efficiently regenerated. Also, the heater and related parts can be reduced, so that the size of the dehumidifier can be reduced.

The term “dehumidifier” as used herein refers to a product that can be used in general households and the like to reduce humidity in air in a room and can be freely positioned at any desired location in the room. The dehumidifier can be used not only for air conditioning (dehumidification) to improve the environment in the room, but also for drying clothes. The dehumidifier used herein is a desiccant dehumidifier that removes the moisture by a moisture absorbing material.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1) Moisture Absorbing Device

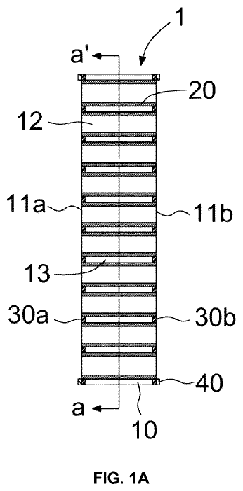

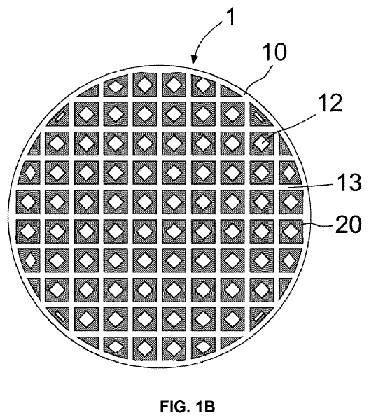

FIG. 1A is a cross-sectional view of a moisture absorbing device for dehumidifiers (which may, hereinafter, be abbreviated as the “moisture absorbing device”) according to an embodiment of the present invention, which is parallel to a flow path direction. Also, FIG. 1B is a cross-sectional view taken along the line a-a′ in FIG. 1A (a cross-sectional view of the moisture absorbing device for dehumidifiers according to an embodiment of the present invention, which is perpendicular to a flow path direction).

As shown in FIGS. 1A and 1B, a moisture absorbing device 1 includes: a honeycomb structure having an outer peripheral wall 10 and partition walls 13 disposed on an inner side of the outer peripheral wall 10 and defining a plurality of cells 12 each extending from a first end face 11a to a second end face 11b to form a flow path; and a moisture absorbing material-containing layer 20 provided on a surface of each of the partition walls 13. Also, the moisture absorbing device 1 can further include: a pair of electrodes 30a, 30b provided on the first end face 11a and the second end face 11b of the honeycomb structure; and terminals 40 connected to the pair of electrodes 30a, 30b. Although FIGS. 1A and 1B show an example in which the pair of electrodes 30a, 30b are provided on the first end face 11a and the second end face 11b of the honeycomb structure, the pair of electrodes 30a, 30b may also be provided on opposing surfaces of the outer peripheral wall 10 parallel to the extension direction of the cells 12.

### Honeycomb Structure

The shape of the honeycomb structure 22 is not particularly limited, and it may be adjusted as needed depending on types of humidifiers in which the moisture absorbing device 1 is used. For example, when the moisture absorbing device 1 is used in place of a conventional rotatable dehumidifying rotor, the outer shape of the cross section orthogonal to the flow direction (the extending direction of the cells 12) of the honeycomb structure may be made circular. The outer shape of the cross section of the honeycomb structure orthogonal to the flow path direction can be, in addition to circle, polygon such as quadrangle (rectangle, square), pentagon, hexagon, heptagon, and octagon, oval (egg-shape, ellipse, oblong, rounded rectangle, etc.), or the like. Each of the end faces (first end face 11a and second end face 11b) has the same shape as the cross section. Also, when the cross section and the end faces are polygonal, the corners may be chamfered.

The shape of each cell 12 is not particularly limited, but it may be polygonal such as quadrangular, pentagonal, hexagonal, heptagonal, and octagonal, circular, or oval in the cross section of the honeycomb structure orthogonal to the flow path direction. These shapes may be alone or in combination of two or more. Moreover, among these shapes, the quadrangle or the hexagon is preferable. By providing the cells 12 having such a shape, it is possible to reduce the pressure loss when the air flows.

The honeycomb structure may be a honeycomb joined body having a plurality of honeycomb segments and joining layers that join outer peripheral side surfaces of the plurality of honeycomb segments together. The use of the honeycomb joined body can increase the total cross-sectional area of the cells 12, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having a PTC (Positive Temperature Coefficient) property, or may contain the same material as the outer peripheral wall 10 and the partition walls 13. In addition to the role of joining the honeycomb segments to each other, the joining material can also be used as an outer peripheral coating material after joining the honeycomb segments.

The honeycomb structure has a thickness of each of the partition walls 13 of 0.089 to 0.140 mm, preferably 0.101 to 0.138 mm. By controlling the thickness of each of the partition walls 13 to such a range, it is possible to suppress an increase in pressure loss while ensuring the strength of the honeycomb structure (moisture absorbing device 1) required for use in the dehumidifier. Also, since the electrical resistance of the honeycomb structure can be controlled to a range suitable for use in the dehumidifier, the honeycomb structure can uniformly be heated while suppressing the flow of excessive current when the voltage is applied.

The thickness of each of the partition walls 13 as used herein refers to the length of the partition wall 13 between adjacent cells 12 in the cross section orthogonal to the flow path direction.

The thickness of the outer peripheral wall 10 of the honeycomb structure is not particularly limited, but it may preferably be 0.05 to 1.00 mm, and more preferably 0.08 to 0.50 mm. By controlling the thickness of the outer peripheral wall 10 to such a range, it becomes easier to ensure the strength of the honeycomb structure (moisture absorbing device 1) required for use in the dehumidifier.

As used herein, the thickness of the outer peripheral wall 10 refers to a length from a boundary between the outer peripheral wall 10 and the outermost cell 12 or partition wall 13 to a side surface of the honeycomb structure 22 of the honeycomb structure in a normal line direction of the side surface in the cross section orthogonal to the flow path direction.

The honeycomb structure has a cell density of 62.0 to 93.0 cells/cm², preferably 62.0 to 88.0 cells/cm². By controlling the cell density to such a range, it is possible to increase the number of cells to a level suitable for use in the dehumidifier while suppressing an increase in pressure loss. As a result, the thickness of the moisture absorbing material-containing layer 20 provided on the surface of the partition wall 13 making up one cell 12 can be reduced, thereby improving an amount of dehumidification. Furthermore, since the electrical resistance of the honeycomb structure can be controlled to a range suitable for use in the dehumidifier, it is possible to uniformly heat the honeycomb structure while suppressing the flow of excessive current when the voltage is applied.

As used herein, the cell density refers a value obtained by dividing a number of cells by an area of one end face (first end face 11a or second end face 11b) of the honeycomb structure (the total area of the partition walls 13 and the cells 12 excluding the outer peripheral wall 10).

The length in the flow path direction and the cross-sectional area orthogonal to the flow path direction of the honeycomb structure may be adjusted according to the required size of the moisture absorbing device 1, and are not particularly limited. For example, when used in a compact moisture absorbing device 1, the honeycomb structure can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 13 forming the honeycomb structure are made of a material that can be heated by electric conduction. Specifically, the partition walls 13 is preferably made of a material having the PTC property. Further, the outer peripheral wall 10 may also be made of the material having the PTC property, as with the partition walls 13, as needed. By such a configuration, the moisture absorbing material-containing layer 20 can be directly heated by heat transfer from the heat-generating partition walls 13 (and optionally the outer peripheral wall 10). Further, the material having the PTC property has characteristics such that when the temperature increases to exceed the Curie point, the resistance value is sharply increased, resulting in a difficulty for electricity to flow. Therefore, when the temperature of the partition walls 13 (and the outer peripheral wall 10 if necessary) becomes high, the current flowing through them is limited, thereby suppressing excessive heat generation of the honeycomb structure. Therefore, it is possible to suppress thermal deterioration of the moisture absorbing material-containing layer 20 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the outer peripheral wall 10 and the partition walls 13 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ) TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃ -based crystalline particles is not particularly limited, but it may generally be 99% by mass, and preferably 98% by mass.

In terms of reduction of the environmental load, it is desirable that the materials used for the outer peripheral wall 10 and the partition walls 13 are substantially free of lead (Pb). More particularly, the outer peripheral wall 10 and the partition walls 13 preferably have a Pb content of 0.01% by mass or less, and more preferably 0.001% by mass or less, and still more preferably 0% by mass. The lower Pb content can allow the air heated by contact with the heat-generating partition walls 13 to be safely applied to organisms such as humans, for example. In the outer peripheral wall 10 and the partition walls 13, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 10 and the partition walls 13 preferably has a Curie point in a temperature range where the resistance becomes twice or more the resistance at room temperature (25° C.). If the Curie point is in such a temperature range, the current flowing through the moisture absorbing device 1 is limited when the moisture absorbing device 1 reaches a high temperature, so that excessive heat generation of the moisture absorbing device 1 is efficiently suppressed. Therefore, thermal deterioration of the moisture absorbing material-containing layer 20 caused by excessive heat generation can be suppressed.

The material making up the outer peripheral wall 10 and the partition walls 13 preferably have a lower limit of a Curie point of 80° C. or more, and more preferably 100° C. or more, and even more preferably 110° C. or more, and still more preferably 125° C. or more, in terms of efficiently heating the moisture absorbing material-containing layer 20. Further, the upper limit of the Curie point is preferably 200° C. or more, and preferably 190° C. or more, and even more preferably 180° C. or more, and particularly preferably 150° C. or more, in terms of safety as a component placed in the interior of the room such as typical households.

The Curie point of the material making up the outer peripheral wall 10 and the partition walls 13 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from Hewlett Packard Japan, G.K.). Based on an electrical resistance-temperature plot obtained by the measurement, a temperature at which the resistance value is twice the resistance value at room temperature (25° C.) is defined as the Curie point.

### Moisture Absorbing Material-Containing Layer 20

The moisture absorbing material-containing layer 20 has a function of adsorbing moisture (water vapor) in the air. The moisture absorbing material-containing layer 20 can be provided on the surface of each of the partition walls 13 (in the case of the outermost cells 12, the partition walls 13 that define the outermost cells 12 and the outer peripheral wall 10). By thus providing the moisture absorbing material-containing layer 20, an amount of moisture absorbed can be increased. Also, the moisture absorbing material-containing layer 20 can be easily heated during the regeneration process, so that the desired dehumidification function by the moisture absorbing material-containing layer 20 can efficiently be regenerated.

Examples of the moisture adsorbing material contained in the moisture absorbing material-containing layer 20 that can be used herein include those which are known in the art, although not particularly limited.

Non-limiting examples of the moisture absorbing material include aluminosilicate, silica gel, silica, graphene oxide, polymer adsorbents, polystyrene sulfonic acid, and metal organic frameworks (MOFs: Metal Organic Frameworks). These may be used alone or in combination of two or more.

Examples of the aluminosilicate that can be preferably used herein include AFI type-, CHA type-, BEA type-, FAU-type, or LTA-type zeolite; and porous clay minerals such as allophane and imogolite. Also, it is more preferable that the aluminosilicate is amorphous.

Examples of the silica gel that can be preferably used herein include type A silica gel.

Examples of the polymer adsorbents that can be preferably used herein include those having polyacrylic acid polymer chains. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The moisture absorbing material-containing layer 20 (i.e., the moisture absorbing material contained in the moisture absorbing material-containing layer 20) is preferably capable of adsorbing moisture and odorous components. By providing the moisture absorbing material-containing layer 20 having such a function, it is possible to not only dehumidify the interior of the room but also remove the odorous components.

Examples of the functional material that can also adsorb the odorous components include zeolite, silica gel, activated carbon, alumina, silica, low-crystalline clay, amorphous aluminum silicate complexes, and the like. Types of the moisture absorbing material may be selected depending on types of components to be removed. The moisture absorbing material may be used alone, or in combination with two or more types.

Specific examples of the odorous components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl) phenyl N-methylcarbamate, and the like.

The moisture absorbing material-containing layer 20 can optionally contain a catalyst. By containing the catalyst, it is possible to promote oxidation-reduction reaction and the like to purify the odorous components. The catalysts having such functions include metal catalysts such as Pt, Pd and Ag, and oxide catalysts such as CeO₂ and ZrO₂. The catalyst may be used alone, or in combination with two or more types. Further, the catalyst can be used in combination with the moisture absorbing material and/or the functional material as described above.

The thickness of the moisture absorbing material-containing layer 20 may be determined according to the size of the cells 12, and is not particularly limited. For example, the thickness of the moisture absorbing material-containing layer 20 is preferably 100 μm or more, and more preferably 120 μm or more, and even more preferably 150 μm or more, from the viewpoint of ensuring sufficient contact with air to increase the amount of moisture absorbed. On the other hand, the thickness of the moisture absorbing material-containing layer 20 is preferably 350 μm or less, and more preferably 340 μm or less, and even more preferably 330 μm or less, from the viewpoint of suppressing separation of the moisture absorbing material-containing layer 20 from the partition walls 13 and the outer peripheral wall 10.

The thickness of the moisture absorbing material-containing layer 20 is measured using the following procedure. Any cross section parallel to the flow path direction of the honeycomb structure is cut out, and a cross-sectional image at magnifications of about 50 is acquired using a scanning electron microscope or the like. Also, this cross section is made to pass through the center of gravity position in the cross section orthogonal to the flow path of the honeycomb structure. The thickness of each moisture absorbing material-containing layer 20 visually recognized from the cross-sectional image is calculated by dividing the cross-sectional area by the length of the cells 12 in the flow path direction. This calculation is performed for all the moisture absorbing material-containing layers 28 visually recognized from the cross-sectional image, and an average value thereof is determined to be the thickness of the moisture absorbing material-containing layer 20.

From the viewpoint of exhibiting the desired function in the moisture absorbing device 1, an amount of the moisture absorbing material-containing layer 20 is preferably 50 to 500 g/L, and more preferably 100 to 400 g/L, and even more preferably 150 to 350 g/L, based on the volume of the honeycomb structure. It should be noted that the volume of the honeycomb structure is a value determined by the external dimensions of the honeycomb structure.

### Pair of Electrodes 30a, 30b

Although the positions of the pair of electrodes 30a, 30b are not particularly limited, but they can be provided on the first end face 11a and the second end face 11b, as shown in FIG. 1A. Further, the pair of electrodes 30a, 30b may be provided on opposite surfaces of the outer peripheral wall 10 parallel to the extending direction of the cells 12.

Applying of a voltage between the pair of electrodes 30a, 30b allows the honeycomb structure to generate heat by Joule heat.

The pair of electrodes 30a, 30b may employ, for example, a metal or alloy containing at least one selected from Cu, Ag, Al, Ni and Si, although not particularly limited thereto. It is also possible to use an ohmic electrode capable of ohmic contact with the outer peripheral wall 10 and/or the partition walls 13 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 30a, 30b may have a single-layer structure, or may have a laminated structure of two or more layers. When the pair of electrodes 30a, 30b have the laminated structure of two or more layers, the materials of the respective layers may be of the same type or of different types.

The thickness of the pair of electrodes 30a, 30b may be appropriately set according to the method for forming the pair of electrodes 30a, 30b. The method for forming the pair of electrodes 30a, 30b includes metal deposition methods such as sputtering, vapor deposition, electrolytic deposition, and chemical deposition. Alternatively, the pair of electrodes 30a, 30b can be formed by applying an electrode paste and then baking it, or by thermal spraying. Furthermore, the pair of electrodes 30a, 30b may be formed by joining metal sheets or alloy sheets.

Each of the thicknesses of the pair of electrodes 30a, 30b is, for example, about 5 to about 80 μm for baking the electrode paste, and about 100 to about 1000 nm for dry plating such as sputtering and vapor deposition, and about 10 to about 100 μm for thermal spraying, and about 5 μm to about 30 μm for wet plating such as electrolytic deposition and chemical deposition. Further, when joining the metal sheet or alloy sheet, its thickness is preferably about 5 to about 100 μm.

### Terminal 40

The terminals 40 are connected to the pair of electrodes 30a, 30b and provided on at least a part of the pair of electrodes 30a, 30b. The provision of the terminals 40 facilitates connection to an external power source. The terminals 40 are connected to conducing wires connected to the external power source.

The terminals 40 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 40 are not particularly limited. For example, the terminals 40 may be provided on a part or the whole of the pair of electrodes 30a, 30b on the outer peripheral wall 10, or may be provided so as to extend outward beyond the outer edges of the pair of electrodes 30a, 30b on the outer peripheral wall 10. Also, the terminals 40 may be provided on a part of the pair of electrodes 30a, 30b on the partition walls 13, or may be provided so as to cover a part of the cells 12. Furthermore, the thickness of the terminal 40 is not particularly limited, but it is, for example, 0.01 to 10 mm, typically 0.05 to 5 mm.

The method of connecting the terminals 40 to the pair of electrodes 30a, 30b is not particularly limited as long as they are electrically connected. For example, they can be connected by diffusion bonding, a mechanical pressing mechanism, welding, or the like.

### Method for Producing Moisture Absorbing Device 1

The method for producing the moisture absorbing device 1 is not particularly limited, and it can be performed according to a known method. Hereinafter, the method for producing the moisture absorbing device 1 will be illustratively described.

A method for producing the honeycomb structure forming the moisture absorbing device 1 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5hours during the increasing of the temperature. The maintaining at 900 to 950° C. for 0.5 to 5 hours can lead to sufficient decomposition of BaCO₃, so that the honeycomb structure having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost. A firing furnace used in the firing step and the degreasing step is not particularly limited, but it may be an electric furnace, a gas furnace, or the like.

On the honeycomb structure thus obtained, the pair of electrodes 30a, 30b are formed. The pair of electrodes 30a, 30b can be formed by metal deposition methods such as sputtering, vapor deposition, electrolytic deposition, and chemical deposition. Further, the pair of electrodes 30a, 30b can also be formed by applying an electrode paste and then baking it. Furthermore, the pair of electrodes 30a, 30b can also be formed by thermal spraying. The pair of electrodes 30a, 30b may be composed of a single layer, but may also be composed of a plurality of electrode layers having different compositions. A typical method for forming the pair of electrodes 30a, 30b will be described below.

First, an electrode slurry containing an electrode material, an organic binder, and a dispersion medium is prepared, and the first end face 11a or the second end face 11b of the honeycomb structure is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure is removed by blowing and wiping. The slurry can be then dried to form the pair of electrodes 30a, 30b on the first end face 11a or the second end face 11b of the honeycomb structure. The drying can be performed while heating the honeycomb structure to a temperature of about 120 to 600° C., for example. Although a series of steps of coating, slurry removal, and drying may be performed only once, the steps can be repeated multiple times to provide the pair of electrodes 30a, 30b having desired thicknesses.

The terminals 40 are then disposed at predetermined positions of the pair of electrodes 30a, 30b, and the pair of electrodes 30a, 30b and the terminals 40 are connected to each other. As a method of connecting the pair of electrodes 30a, 30b to the terminals 40, the method described above can be used. It should be noted that the terminals 40 may be disposed after forming a moisture absorbing material-containing layer 20 described below.

The moisture absorbing material-containing layer 20 is then formed on the surfaces of the partition walls 13 and the like of the honeycomb structure.

Although the method for forming the moisture absorbing material-containing layer 20 is not particularly limited, it can be formed, for example, by the following steps. The honeycomb structure is immersed in a slurry containing a dehumidifying material, an organic binder, and a dispersion medium for a predetermined period of time, and an excess slurry on the end faces and the outer periphery of the honeycomb structure is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the moisture absorbing material-containing layer 20 on the surface of each of the partition walls 13. The drying can be performed while heating the honeycomb structure to a temperature of about 120 to 600° C., for example. Although a series of steps of immersion, slurry removal, and drying may be performed only once, the steps can be repeated multiple times to provide the moisture absorbing material-containing layer 20 having the desired thickness on the surface of each of the partition walls 13 and the like.

### (2) Dehumidifier

The dehumidifier according to an embodiment of the present invention includes the moisture absorption device 1 as described above.

The moisture absorption device 1 can heat the honeycomb structure by applying the voltage to the honeycomb structure without using any heater. Therefore, in contrast to the conventional dehumidifying rotors that are indirectly heated via the air heated by the heater, the dehumidifier according to the embodiment of the present invention can directly heat the moisture absorbing material-containing layer 20 in the moisture absorption device 1, so that it can reduce the heat loss and can efficiently regenerate the moisture absorbing material-containing layer 20. Also, the dehumidifier according to the embodiment of the present invention does not require the use of the heater, and the heater and related parts can be reduced, making it possible to reduce the size.

The structure of the dehumidifier according to the embodiment of the present invention is not particularly limited as long as it includes the moisture absorbing device 1 as described above, and a known structure can be adopted. That is, the moisture absorbing device 1 can be used as an alternative for the rotatable dehumidifying rotor in the conventional dehumidifier. It can also be used as an alternative for a fixed dehumidifying member in the conventional dehumidifier. When it is used as the fixed dehumidifying member, for example, a sliding flap can be provided in the flow path, and the flap can be switched to perform dehumidification by the dehumidifying member and regeneration of the dehumidifying member. However, in contrast to the known dehumidifiers, it is preferable that the dehumidifier according to the embodiment of the present invention does not include any heater and related parts.

Hereinafter, a structure example of the dehumidifier according to the embodiment of the present invention will be described.

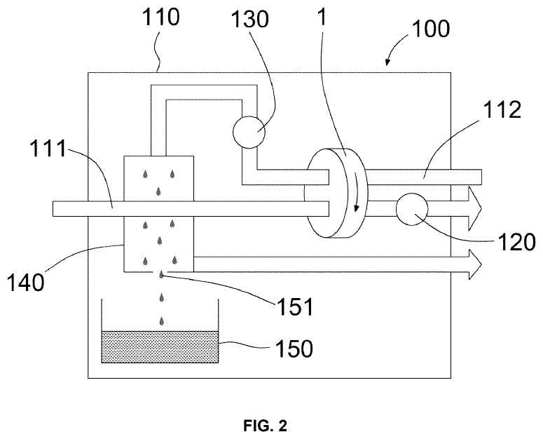

FIG. 2 is a schematic view of the dehumidifier according to the embodiment of the present invention.

As shown in FIG. 2, a dehumidifier 100 includes: a casing 110 having a dehumidification flow path 111 and a regeneration flow path 112; a moisture absorbing device 1 rotatably disposed across the dehumidification flow path 111 and the regeneration flow path 112; a first fan 120 disposed in the dehumidification flow path 111 and sucking ambient air to discharge the air dehumidified by the moisture absorbing device 1 to the surroundings; a second fan 130 disposed in the regeneration flow path 112 and circulating the air dehumidified by the moisture absorbing device 1; a heat exchanger 140 disposed in the regeneration flow path 112 and cooling and condensing the air dehumidified by the moisture absorbing device 1; and a tank 150 for storing condensed water 151 generated by the heat exchanger 140. The moisture absorbing device 1 can be heated by applying the voltage to release the moisture. Such a configuration allows the dehumidifier 100 having the above effects to be easily achieved. The dehumidifier 100 may further include known components such as a control unit (not shown) for controlling the moisture absorbing device 1, the first fan 120, the second fan 130, and the like. The casing 110 can be composed of a plurality of members (e.g., cover members). The casing 110 has an intake port for taking ambient air into the dehumidifier 100 and an exhaust port for discharging the air in the dehumidifier to the outside.

The dehumidification flow path 111 is a flow path that extends from the intake port to the exhaust port of the casing 110. In the middle of the dehumidification flow path 111, there are disposed the moisture absorbing device 1 that adsorbs the moisture contained in the air passing through the dehumidification flow path 111, and the first fan 120 for forming the flow of the air.

The regeneration flow path 112 is a flow path for removing the adsorbed moisture from the moisture absorbing device 1. In the middle of the regeneration flow path 112, there are disposed the second fan 130 for forming the flow of the air dehumidified by the moisture absorbing device 1 and the heat exchanger 140 for cooling and condensing the air.

The moisture absorbing device 1 is rotatably disposed across the dehumidification flow path 111 and the regeneration flow path 112. The rotation of the moisture absorbing device 1 can be achieved by a known structure. For example, the moisture absorbing device 1 may be configured to be supported by a central shaft.

The first fan 120 and the second fan 130 are not particularly limited, and known fans such as sirocco fans can be used. The heat exchanger 140 is not particularly limited, and known heat exchangers may be used.

In the dehumidifier 100 having the above structure, for the dehumidification mode, the first fan 120 is driven to cause the ambient air to flow through the dehumidification flow path 111. In the dehumidification flow path 111, when the ambient air taken from the intake port of the casing 110 passes through the moisture absorbing device 1, the moisture is adsorbed by the moisture absorbing material-containing layer 20 making up the moisture absorbing device 1, and then the dry air is discharged from the exhaust port of the casing 110.

On the other hand, for the regeneration mode, the second fan 130 is driven to cause the air to flow through the regeneration flow path 112. In the regeneration flow path 112, the voltage is applied to the moisture absorbing device 1, whereby the moisture absorption device 1 (the honeycomb structure and the moisture absorbing material-containing layer 20) is heated, so that the adsorbed moisture is released from the moisture absorbing material-containing layer 20 into the air. At this time, the air is in a hot and high humidity state. This air is cooled by the heat exchanger 140, and condensed water 151 is generated. The condensed water 151 is led to the tank 150.

In the regeneration mode, the voltage applied to the moisture absorbing device 1 is 12 V or more and less than 200 V, preferably 15 to 150 V, from the viewpoint of preventing electric shock. Since the honeycomb structure used in the moisture absorbing device 1 has low electrical resistance at room temperature, it is possible to heat the honeycomb structure at such a relatively low driving voltage.

### Description of Reference Numerals

1 moisture absorbing device
10 outer peripheral wall
11a first end face
11b second end face
12 cell
13 partition wall
20 moisture absorbing material-containing layer
30a, 30b pair of electrodes
40 terminal
100 dehumidifier
110 casing
111 dehumidification flow path
112 regeneration flow path
120 first fan
130 second fan
140 heat exchanger
150 tank
151 condensed water

1. A moisture absorbing device for humidifiers, the device comprising:
a honeycomb structure having an outer peripheral wall and partition walls disposed on an inner side of the outer peripheral wall, the partition walls defining a plurality of cells, each of the cells extending from a first end face to a second end face to form a flow path; and
a moisture absorbing material-containing layer provided on a surface of each of the partition walls,
wherein the honeycomb structure has a thickness of each of the partition walls of 0.089 to 0.140 mm and a cell density of 62.0 to 93.0 cells/cm².

2. The moisture absorbing device for dehumidifiers according to claim 1, wherein at least the partition walls are made of a material having a PTC property.

3. The moisture absorbing device for dehumidifiers according to claim 1, wherein the thickness of each of the partition walls is 0.101 to 0.138 mm.

4. The moisture absorption device for dehumidifiers according to claim 1, further comprising: a pair of electrodes provided on the first end face and the second end face of the honeycomb structure, or on opposing surfaces of the outer peripheral wall parallel to an extension direction of the cells; and terminals connected to the electrodes.

5. The moisture absorbing device for dehumidifiers according to claim 1, wherein the moisture absorbing material-containing layer is capable of absorbing moisture and odorous components.

6. A dehumidifier comprising the moisture absorbing device for dehumidifiers according to any one of claim 1.

7. A dehumidifier comprising:
a casing having a dehumidification flow path and a regeneration flow path;
the moisture absorbing device for dehumidifiers according to claim 1, the moisture absorbing device being rotatably disposed across the dehumidification flow path and the regeneration flow path;
a first fan disposed in the dehumidification flow path, the first fan sucking ambient air to discharge the air dehumidified by the moisture absorbing device for dehumidifiers to the surroundings;
a second fan disposed in the regeneration flow path, the second fan circulating the air dehumidified by the moisture absorbing device for dehumidifiers;
a heat exchanger disposed in the regeneration flow path, the heat exchanger cooling and condensing the air dehumidified by the moisture absorbing device for dehumidifiers; and
a tank for storing condensed water generated by the heat exchanger,
wherein the moisture absorbing device for dehumidifiers can be heated by applying a voltage to release the moisture.

8. The dehumidifier according to claim 7, wherein the voltage applied to the moisture absorbing device for dehumidifiers is 12 V or more and less than 200 V.
